(19) United States
(12) Patent Application Publication
(10) Pub. No.: US 2023/0011794 A1
(43) Pub. Date: Jan. 12, 2023

(54) CONTROLLED FRICTION INTERFACING

(71) Applicant: INVONU LLC, Goleta, CA (US)

(72) Inventors: Joseph J. Skaja, Hermosa Beach, CA (US); Stuart Jenkins, Goleta, CA (US)

(21) Appl. No.: 17/861,474

(22) Filed: Jul. 11, 2022

Related U.S. Application Data
(60) Provisional application No. 63/220,835, filed on Jul. 12, 2021.

(51) Int. Cl. A43B 17/00; A43B 7/28

(52) U.S. Cl. CPC A43B 17/00; A43B 7/28

(57) ABSTRACT

The present invention is directed to articles of manufacture having at least a portion The present invention is directed to articles of manufacture (and a method for forming such an article) having at least a portion prepared using high coefficient friction material as an interface for human contact using, but not limited to, polymeric materials. The articles may be incorporated into any product or any portion of a product where non-slip properties are required during human contact and usage. Preferably, a thermoplastic material such as thermoplastic urethane with very durable but soft properties is accurately texturized to achieve optimum frictional properties for a given application. The textures are carefully calculated for the desired friction characteristics. The invention further provides methods of preparing articles made with the interface that are characterized by their excellent economic benefits, ease of use, environmental benefits and functional advantages.

### CROSS-REFERENCE TO RELATED APPLICATIONS

This is a nonprovisional application of U.S. Provisional Application No. 63/220,835, filed on Jul. 12, 2021, the entirety of which is incorporated herein by reference.

### BACKGROUND OF THE INVENTION

### (1) Field of Invention

The present invention relates to a process for creating an item with a controlled friction interface and, more particularly, to an insole or other item with an outer surface or interface that includes a controlled texture for controlled friction interfacing.

### (2) Description of Related Art

Insoles and other items have external surfaces with varied texture. Typically, an item is simply molded or formed with a desired texture. While generally operable, it may be desirable to precisely control the exterior surface or interface to alter the coefficient of friction of said item.

Thus, a continuing need exists for process for creating an item with a controlled friction interface.

### SUMMARY OF INVENTION

The present invention is directed to articles of manufacture (and a method for forming such an article) having at least a portion prepared using high coefficient friction material as an interface for human contact using, but not limited to, polymeric materials. The articles may be incorporated into any product or any portion of a product where non-slip properties are required during human contact and usage. Preferably, a thermoplastic material such as thermoplastic urethane with very durable but soft properties is accurately texturized to achieve optimum frictional properties for a given application. The textures are carefully calculated for the desired friction characteristics. The invention further provides methods of preparing articles made with the interface that are characterized by their excellent economic benefits, ease of use, environmental benefits and functional advantages.

In one aspect, the method of the present disclosure is directed to forming an article of manufacture with a predetermined friction interface, comprising acts of selecting a desired material; selecting a desired texture to form a friction pad with a predetermined frictional interface; generating a mold for the article of manufacture; heating the desired material; positioning the desired material into the mold; and pressing the material against the desired texture to cause the material to receive an imprint of the desired texture, thereby forming the article of manufacture (e.g., shoe insole, etc.) with a friction pad having a predetermined frictional interface. Finally, as can be appreciated by one in the art, the present invention also comprises the articles of manufacture formed according to the described methods and using the items as described herein.

### BRIEF DESCRIPTION OF THE DRAWINGS

The objects, features and advantages of the present invention will be apparent from the following detailed descriptions of the various aspects of the invention in conjunction with reference to the following drawings, where:

FIG. 1 is an illustration of an article of manufacture having at least a portion prepared using high coefficient friction material as an interface for human contact;

FIG. 2 is an illustration depicting various textures with an increasing coefficient of friction; and

FIG. 3 is an illustration depicting a method for forming an item with a controlled friction interface.

### DETAILED DESCRIPTION

The present invention relates to a process for creating an item with a controlled friction interface and, more particularly, to an insole or other item with an outer surface or interface that includes a controlled texture for controlled friction interfacing. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is only one example of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

Please note, if used, the labels left, right, front, back, top, bottom, forward, reverse, clockwise and counter clockwise have been used for convenience purposes only and are not intended to imply any particular fixed direction.

Instead, they are used to reflect relative locations and/or directions between various portions of an object.

### (1) Description

As noted above, the present disclosure is directed to an item and a method for creating such an item with a controlled friction interface. Wherever a product has human contact during usage, materials and the texture of these materials is modified for optimum frictional properties. This surface is further enhanced by using appropriate materials to get the desired frictional result. In the case using the interfacing for an insole, for instance, the traction of the insole to the human foot can be increased or decreased for optimum performance. For example, an insole with a great degree of traction helps stick to a sock so that the sock does not slide and, in doing so, provides the athlete with enhanced performance and reliability. Increasing or decreasing the traction is accomplished by varying formulations and texture of the contact surface. A desired material is thermoplastic or thermoset polyurethane, but any material can be used for this purpose and process. The precise texture desired is imprinted directly to the polymer prior to actual part molding or can be done at the same time, or even after final molding the part. The precise texture is controlled geometrically and for its depth. Desirably, the depth between the geometric shapes in a pattern can range from 0.01 mm to 6 mm.

These contact surfaces can easily be incorporated into the final product assembly at very little or no additional cost. These materials fit seamlessly into current manufacturing processes. The textured material can also be formulated to be friendly to a particular product process or another material. Although depicted with respect to insoles, the invention is not intended to be limited thereto as it can used to create any desired item, non-limiting examples of which include bicycle grips, door-knob grips, tool and power tool grips, internal friction pads, handle grips of all types, formed to have transparent skin contact materials, formed to have opaque skin contact materials, and sports equipment. This technology could apply to other things such as bike seats, standing mats, yoga blocks and yoga mats. The process can be applied to any product where you are trying to control the slip or grip on the surface of the product.

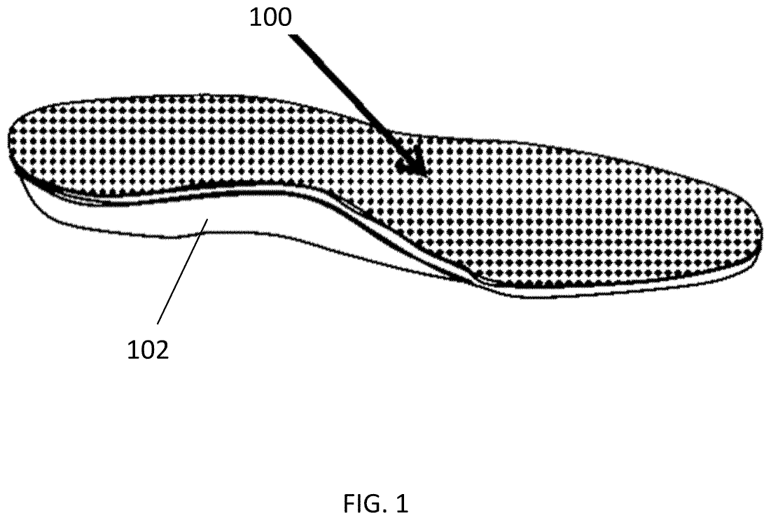

As referenced above and as shown in FIG. 1, the process is used to increase the coefficient of friction of a friction pad 100 of the insole 102 (or other item) so that it holds the contacting item (e.g., sock or foot) in place. Thus, in this aspect, the friction pad 100 (i.e., top surface) of the insole 102 is imprinted with the desired texture to provide a frictional surface with the controlled coefficient of friction interfacing. In the example as shown, the insole 102 has a single friction pad 100; however, the invention is not intended to be limited thereto as more than one friction pad can be attached to a product, or different frictional pads within the final product can have different properties (e.g., formed of different materials or different textures, or formed of a different material than the base substrate to which the friction pad is attached).

The process can be used to adjust or tune the coefficient of friction for activities if desired. The texture is applied by putting the selected pattern in the mold for the part, either physically or by placing a material with the proper texture in the mold. The texture is achieved as the plastic takes on that texture as it is heated and pressed. In another aspect, the texture can be imprinted onto the part after the part is molded into its desired shape, such as an insole. In this aspect, the insole is formed and subsequently imprinted with the desired texture.

The coefficient of friction is increased in the friction pad by choosing a material that is similar or has by nature a different coefficient of friction than the typical materials used in a sock (or other contacting item). The reason socks slide on insoles is that both the socks and insoles are normally both made of fabrics that have similar coefficients of friction. For example, the top of an insole typically has a fabric layer, which is cloth, like the sock, and has a similar coefficient of friction. Thus, to prevent the sock from slipping against the insole, the outer surface of the insole needs to be formed to increase its coefficient of friction.

In one aspect, it is desirable to also form the insole or other item out of materials that also are hydrophobic to prevent the coefficient of friction from decreasing when the sock or foot is wet. Thus, it is desirable to have a high coefficient of friction when wet just like when dry.

Once the material is selected that will not let a sock or foot slide on it easily, a rough or textured surface is put into that material. A non-limiting example of such a material is a thermoplastic or thermoset polyurethane. The rough or textured surface is put into the material by heating the material and it takes the shape of the surface that it is pressed against when heated (e.g., such as pressing the material against a mold with the desired texture). This texture or surface shape is achieved just the way you would when you have playdough and want to press it onto a quarter or other mold-shape. When you press the play dough onto the shaped item (e.g., quarter), the reflection of the quarter is impressed into the surface of the playdough. When there is a textured surface in or on top of the molds and the heated plastic sheet is pressed into the mold, it reflects the textured surface that it is being pressed against to form the friction pad.

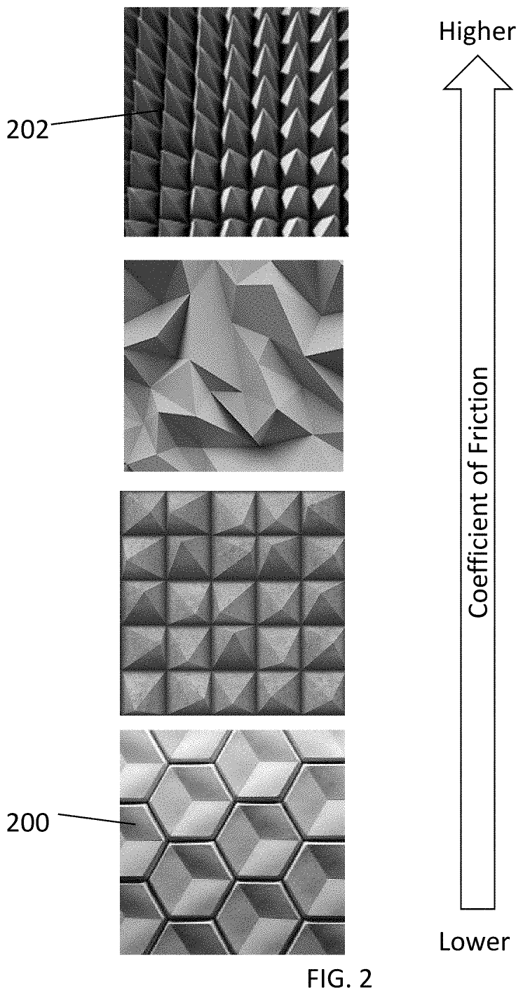

As shown in FIG. 2, if it is desired to have an item with a higher coefficient of friction (i.e., more sticky), a rougher or bigger texture pattern 200 is used in the process. If it is desired to have a lower coefficient of friction, a smaller texture pattern 202 is used. A second method of tuning the coefficient of friction is to change the material used on the top surface (i.e., friction pad) of the insole. For example, for a super high coefficient of friction, a very soft plastic or rubber is used. Alternatively, for a lower coefficient of friction, a stiff or harder material is used. A non-limiting example of such a stiff or harder material is a hard plastic or material, like Nylon.

An example of the effects of friction interfacing is when a person is in stocking feet or socks at home, that person will slide a lot on a hardwood floor but not on a carpet. A stiff material is like a wood floor in that the socks slide easily. Alternatively, a soft material is like the foam of a yoga mat where socks will not slide as easily. In a golf shoe, it may be desirable to have a texture that provides a very high coefficient of friction. In a long-distance running shoe, it is desirable to control movement at the extreme, but in the normal running gait let it give a bit. Thus, the need to adjust coefficients of friction varies based on the particular application.

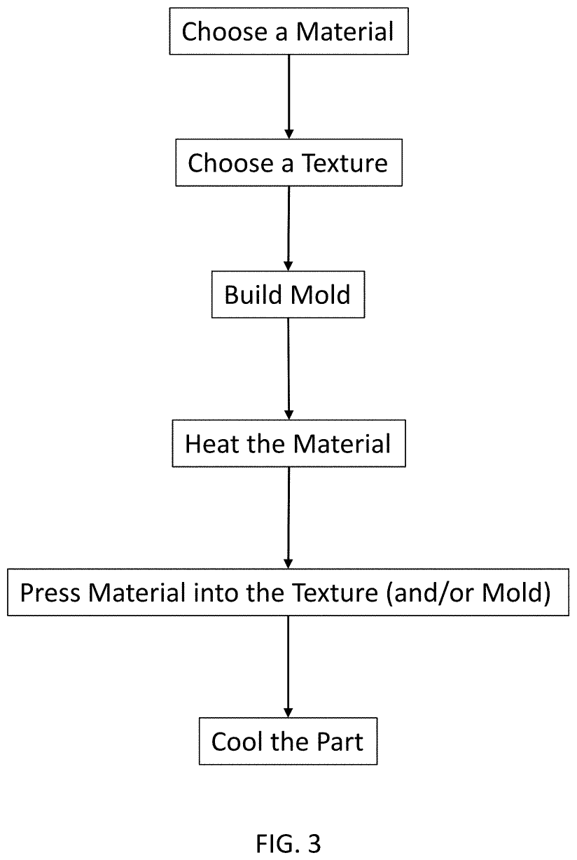

The general acts for the process are depicted in FIG. 3 and as follows:
a. Choose a material (e.g., thermoset polyurethane, etc.);
b. Choose a texture (e.g., bigger texture pattern 200 shown in FIG. 2, etc.);
c. Build a mold for an item, with the selected texture built into it or use a fabric or material to cover the mold to create a texture;
d. Heat the material;
e. Press the material into the texture and/or mold until it takes an imprint of the desired texture to form a molded item with a friction pad on an exterior surface of the item (e.g., the insole in FIG. 1, etc.); and
f. Cool the part.

Thus, as can be appreciated, the process as described above can be used to generate a desired item with the selected texture to control the friction interfacing. It should be noted that the ordering of acts (a) through (c) can be changed as desired, provided that the material is heated and pressed into or with a texture to generate the resulting item with the desired friction interfacing.

It should be understood that the specific examples and materials described above are non-limiting examples and that the invention is not intended to be limited thereto. Finally, while this invention has been described in terms of several embodiments, one of ordinary skill in the art will readily recognize that the invention may have other applications in other environments. It should be noted that many embodiments and implementations are possible. Further, the following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”. Further, while particular method steps have been recited in a particular order, the method steps may occur in any desired order and fall within the scope of the present invention.

What is claimed is:

1. An article of manufacture, comprising:
an item formed of a material, the item having an exterior surfacing forming a friction pad, wherein the friction pad is imprinted to have a predetermined frictional interface.

2. The article of manufacture as set forth in claim 1, wherein the item is a shoe insole.

3. A method for forming an article of manufacture with a predetermined friction interface, comprising acts of:
selecting a desired material;
selecting a desired texture to form a friction pad with a predetermined frictional interface;
generating a mold for the article of manufacture;
heating the desired material;
positioning the desired material into the mold; and
pressing the material against the desired texture to cause the material to receive an imprint of the desired texture, thereby forming the article of manufacture with a friction pad having a predetermined frictional interface.

4. The method as set forth in claim 1, wherein the article of manufacture is a shoe insole.
